(19) United States
(12) Patent Application Publication
(10) Pub. No.: US 2011/0119837 A1
(43) Pub. Date: May 26, 2011

(54) Washing Agent That Is Gentile on Textiles

(76) Inventors: Anette Nordskog, Sandefjord (NO); Wolfgang Von Rybinski, Duesseldorf (DE); Dorota Sendor-Mueller, Duesseldorf (DE); Birgit Middelhauve, Monheim (DE); Siglinde Erpenbach, Monheim (DE); Peter Schmiedel, Duesseldorf (DE); Stefan Leopold, Duesseldorf (DE); Ursula Huchel, Koeln (DE); Thomas Weber, Dormagen (DE); Rudi Van Eldik, Marloffstein (DE); Erika Ember, Erlangen (DE)

(21) Appl. No.: 12/952,578

(22) Filed: Nov. 23, 2010

Related U.S. Application Data
(63) Continuation of application No. PCT/EP2009/055794, filed on May 14, 2009.

(30) Foreign Application Priority Data
May 23, 2008 (DE) 10 2008 024 800.2
Sep. 2, 2008 (DE) 10 2008 045 297.1

(51) Int. Cl. D06L 1/00; C11D 3/395

(52) U.S. Cl. 8/137; 252/186.42

(57) ABSTRACT

Reduction of damage to textiles caused when bleach active catalysts are used when washing the textiles, without influencing bleaching performance. The invention relates to a method for washing textiles in the presence of a peroxygenated bleaching agent and a bleach boosting transition metal complex, wherein the method is carried out when water hardness is between 0° dH-3° dH.

### CROSS REFERENCE TO RELATED APPLICATIONS

The present application is a continuation of International Patent Application No. PCT/EP2009/055794 filed 14 May 2009, which claims priority to German Patent Application Nos. 10 2008 024 800.2 filed 23 May 2008 and 10 2008 045 297.1 filed 2 Sep. 2008, all applications incorporated herein by reference.

The present invention relates to a method for washing textiles in the presence of a peroxygenated bleaching agent and a bleach-boosting transition metal complex, the method being gentle on textiles, to the use of cation-complexing, cation-exchanging or cation-precipitating substances for reducing damage caused to textiles by bleach-boosting transition metal complexes when washing textiles, and to agents containing peroxygenated bleaching agent, bleach-boosting transition metal complex and cation-complexing, cation-exchanging or cation-precipitating substances.

Inorganic peroxygen compounds, particularly hydrogen peroxide and solid peroxygen compounds which dissolve in water releasing hydrogen peroxide (e.g., sodium perborate and sodium carbonate perhydrate) have long been used as oxidizing agents for disinfecting and bleaching purposes. In dilute solutions, the oxidizing action of these substances is very dependent on temperature. Thus, with H₂O₂ or perborate, for example, in alkaline bleaching liquors, a sufficiently rapid bleaching of soiled textiles is achieved only at temperatures above around 80° C.

At lower temperatures, the oxidizing action of inorganic peroxygen compounds can be improved by adding bleach activators, of which many suggestions have been proposed in the literature. These include the substance classes of N- or O-acyl compounds, for example, polyacylated alkylene diamines, particularly tetraacetyl ethylene diamine, acylated glycolurils, particularly tetraacetyl glycoluril, N-acylated hydantoins, hydrazides, triazoles, hydrotriazines, urazoles, diketopiperazines, sulfuryl amides and cyanurates, as well as carboxylic anhydrides, particularly phthalic anhydride, carboxylic acid esters, particularly sodium nonanoyloxy benzene sulfonate, sodium isononanoyloxy benzene sulfonate and acylated sugar derivatives such as pentaacetyl glucose. The bleaching action of aqueous peroxide liquors can be increased by addition of these substances so that substantially the same actions occur at temperatures of around 60° C. as occur with peroxide liquor alone at 95° C. Damage to fabric then remains within limits that are acceptable to the consumer.

In a move towards energy-saving washing and bleaching methods, application temperatures well below 60° C., particularly below 45° C. and down to cold water temperature have gained in importance in recent years.

At these lower temperatures, action of known activator compounds generally decline perceptibly. There has therefore been many attempts to develop more effective bleaching systems for this temperature range. One such attempt involves use of hydrogen-peroxide-yielding compounds together with transition metal salts and complexes as bleach catalysts. However, these bleach catalysts present a risk of oxidative damage to the textiles, presumably because of the high reactivity of the oxidizing intermediates produced by them and by the peroxygen compound. Use of such transition metal catalysts in washing agents has been made more difficult in practice because damage to the fabric is significantly greater than with a conventional peracid-forming system comprising bleaching agent and bleach activator.

The present invention is therefore directed towards reducing damage to textiles through use of bleach-active catalysts when washing the textiles without substantially influencing the bleaching performance.

In a first aspect, the invention provides a method for washing textiles in the presence of a peroxygenated bleaching agent and a bleach-boosting transition metal complex, wherein the method is performed at a water hardness of 0° dH (dH=degree hardness) to 3° dH, in particular 0° dH.

Suitable bleach-activating transition metal complex compounds include those of the metals Fe, Mn, Co, V, Ru, Ti, Mo, W, Cu and/or Cr, for example, manganese, iron, cobalt, ruthenium or molybdenum salt complexes known from German patent application DE 195 29 905 A1 and their N-analog compounds known from German patent application DE 196 20 267 A1; manganese, iron, cobalt, ruthenium or molybdenum carbonyl complexes known from German patent application DE 195 36 082 A1; manganese, iron, cobalt, ruthenium, molybdenum, titanium, vanadium and copper complexes with nitrogen-containing tripod ligands described in German patent application DE 196 05 688 A1; cobalt, iron, copper and ruthenium ammine complexes known from the German patent application DE 196 20 411 A1; manganese, copper and cobalt complexes described in German patent application DE 44 16 438 A1; cobalt complexes described in European patent application EP 0 272 030 A2; manganese complexes known from European patent application EP 0 693 550 A2; manganese, iron, cobalt and copper complexes known from European patent application EP 0 392 592 A2; and/or manganese complexes described in European patent application EP 0 443 651 A2 or in European patent applications EP 0 458 397 A2, EP 0 458 398 A2, EP 0 549 271 A1, EP 0 549 272 A1, EP 0 544 490 A1 and EP 0 544 519 A2.

Preferred bleach-boosting transition metal complex compounds include metal complexes according to formula (I)—

[LₙMₘXₚ]^{Z}Y_{q} (I)

wherein M is manganese or iron or mixtures of these metals, which can be present in oxidation state II, III, IV or V, or in mixtures thereof; n and m are independently of one another whole numbers having a value from 1 to 4; X is a coordinating or bridging species; p is a whole number having a value from 0 to 12; Y is a counterion whose type is dependent on the charge z of the complex, which can be positive, zero or negative; q=z/[charge Y]; and L is a ligand which is a macrocyclic organic molecule of the general formula—

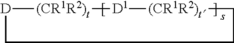

wherein each of residues R¹ and R² can be zero, H, alkyl or aryl, optionally substituted; t and t′ are independently of one another 2 or 3; D and D¹ are independently of one another N, NR, PR, O or S, where R is H, alkyl or aryl, optionally substituted; and s is a whole number having a value from 2 to 5, where, if D=N, one of the heterocarbon bonds bonded thereto is unsaturated, leading to formation of an N═CR¹ section. The preferred metal M is manganese. The coordinating or bridging species X is preferably a small coordinating ion or bridging molecule or a mixture thereof, for example, water, OH⁻, O²⁻, —S(═O)—, N³⁻, HOO⁻, O₂²⁻, O₂⁻, amine, Cl⁻, SCN⁻, N₃⁻, and carboxylate, such as acetate or mixtures thereof. If charge z is positive, Y is an anion such as chloride, bromide, iodide, nitrate, perchlorate, rhodanide, hexafluorophosphate, sulfate, alkyl sulfate, alkyl sulfonate or acetate; if charge z is negative, Y is a cation such as an alkali ion, ammonium ion or alkaline-earth ion. Preferred ligands L include 1,4,7-triazacyclononane, 1,4,7-trimethyl-1,4,7-triazacyclononane, 1,5,9-trimethyl-1,5,9-triazacyclododecane and 1,2,4,7-tetramethyl-1,4,7-triazacyclononane.

In a further preferred embodiment, the bleach-boosting transition metal complex compound corresponds to general formula (II)—

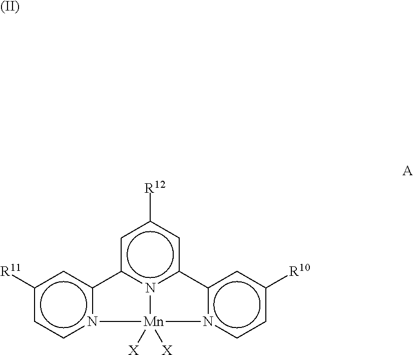

wherein R¹⁰ and R¹¹, independently of one another, are hydrogen, C₁₋₁₈ alkyl group, —NR¹³R¹⁴ group, —N⁺R¹³R¹⁴R¹⁵ group or

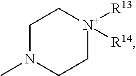

R¹² is hydrogen, —OH or a C₁₋₁₈ alkyl group; R¹³, R¹⁴ and R¹⁵, independently of one another, are hydrogen, C₁₋₄ alkyl or hydroxyalkyl group; and X is halogen and A is a charge-equalizing anion ligand which, depending on its charge and on the type and number of other charges, in particular the charge of the manganese central atom, can also be absent or present multiple times. In complexes according to formula (I), manganese can be present in oxidation state II, III, IV or V. If desired, albeit less preferably, other transition metals such as Fe, Co, Ni, V, Ru, Ti, Mo, W, Cu and/or Cr, can be present in such complex compounds in place of the Mn central atom.

The method according to the invention can be performed at temperatures in the range from 10° C. to 95° C. if desired. The temperature is preferably in the range from 20° C. to 40° C.

In order to optimize reduction of textile damage through the method according to the invention, it is normally not sufficient to run a washing machine with demineralized or ion-exchanged water, or to use corresponding water for hand washing, because although the water hardness before actual start of the washing process is 0° dH, Ca and/or Mg ions, presumably present in small amounts in the ingredients of the washing agent used for washing or in the dirt on the textile to be washed, are released during the washing program, thereby increasing water hardness. In order to avoid this, cation-complexing, cation-exchanging and/or cation-precipitating substances are preferably additionally used in the method according to the invention. It is preferable to introduce a larger amount of these substances into the washing liquor than would be necessary to adjust the water hardness in the washing liquor to a value in the range from 0° dH to 3° dH, and in particular additionally to use cation-complexing substances even with a water hardness of 0° dH. In particular, it is preferable to use cation-complexing, cation-exchanging and/or cation-precipitating substances in such amounts that the water hardness remains in the cited range at least for the period during which the system comprising peroxygenated bleaching agent and bleach-boosting transition metal complex develops its bleaching performance. These additives are described in more detail below in connection with builder substances or surfactants which can be used in the washing agents. Examples of such additives are phosphonates (such as HEDP or DPTMP), complexing polymers, particularly polycarboxylates (such as Sokalan® CP 5), ion-exchanging substances such as Zeolite A (Sasil®), Zeolite P and Zeolite X, or complexing surface-active substances, particularly anionic surfactants (such as linear alkylbenzene sulfonates), which can be used in any combination if desired. The invention therefore also provides for use of cation-complexing, cation-exchanging or cation-precipitating substances to reduce damage to textiles when washing textiles due to bleach-boosting transition metal complexes. In this embodiment of the invention, it is possible to use conventional service water, which typically has a water hardness above 0° dH. In a preferred embodiment, more cation-complexing, cation-exchanging and/or cation-precipitating substance is used than is necessary to obtain a water hardness of 0° dH, although it can also optionally be possible to use less cation-complexing, cation-exchanging and/or cation-precipitating substance than is necessary to obtain a water hardness of 3° dH.

If phosphonates are used in the method according to the invention, the concentration of phosphonate in the washing liquor is preferably 0.01 mmol/l to 10 mmol/l, particularly 0.1 mmol/l to 2 mmol/1.

If complexing polymers are used in the method according to the invention, the concentration of complexing polymer in the washing liquor is preferably 0.001 g/l to 5 g/l, particularly 0.01 g/l to 1 g/l.

If ion-exchanging substances are used in the method according to the invention, the concentration of ion-exchanging substance in the washing liquor is preferably 0.01 g/l to 100 g/l, particularly 0.1 g/l to 10 g/l.

If complexing surface-active substances are used in the method according to the invention, the concentration of complexing surface-active substance in the washing liquor is preferably 0.01 g/l to 50 g/l, particularly 0.02 g/l to 10 g/1.

Preferred peroxygen concentrations (calculated as H₂O₂) in the washing liquor are in the range from 0.001 g/l to 10 g/l, particularly 0.1 g/l to 1 g/l. The concentration of bleach-boosting transition metal complex in the washing liquor is preferably in the range from 0.1 μmol/l to 100 μmol/l, particularly 1 μmol/l to 20 μmol/l.

The method according to the invention can be performed, for example, by adding peroxygenated bleaching agent, bleach-boosting transition metal complex and optionally cation-complexing, cation-exchanging and/or cation-precipitating substances separately to a washing solution, which can contain a conventional washing agent. It is also possible that, rather than the final bleach-boosting transition metal complex, one or more ligands which can form a bleach-boosting transition metal complex with a transition metal in situ in the washing process are used separately. The transition metal can then likewise be added separately in the form of a salt or non-bleach-boosting complex, or be introduced into the washing process as a constituent of the service water used for the process or via the textile to be cleaned (e.g., as a constituent of the dirt removed). It is possible and preferable here for the bleach-boosting transition metal complex and cation-complexing, cation-exchanging and/or cation-precipitating substance to be introduced into the washing process together at the same time, preferably as a hydrous premix or as a premix in the form of an aqueous solution.

Premixing of a bleach-boosting transition metal complex with phosphonates (such as HEDP or DPTMP), each of which can be present as a hydrous preparation, is preferred, the phosphonate presumably binding to the transition metal central atom complex as a co-ligand, optionally with the loss of other ligands (X in formulas I and II). It is preferable for the pH of the hydrous mixture of transition metal complex and phosphonate to be adjusted to values in the range from pH 5 to pH 12, particularly from pH 7 to pH 11, and more particularly from pH 8 to pH 10, optionally through addition of system-compatible acids or bases. Water hardness in this hydrous mixture can be 0° dH to 30° dH if desired, particularly 0° dH to 10° dH. Bleach-boosting transition metal complex and phosphonate are preferably used in molar ratios of 10:1 to 1:10, particularly 1:1 to 1:2. The mixed complex thus formed at temperatures preferably in the range from 10° C. to 100° C., particularly 30° C. to 80° C., can either be added to the washing liquor as a solution or isolated first, if desired by adding salts such as alkali or ammonium sulfate, hydrogen sulfate, carbonate, hydrogen carbonate, phosphate, hydrogen phosphate, dihydrogen phosphate or similar to the aqueous system, particularly in concentrations of 0.01 mol/1 to 1 mol/l, more particularly 0.1 mol/l to 0.7 mol/l, and incorporated into a washing or cleaning agent formulation as a separate substance or used in the context of the use or method according to the invention.

It is also preferable in a washing process to incorporate the cation-complexing, cation-exchanging and/or cation-precipitating substance into the washing process first, followed after a few minutes, for example, with the bleach-boosting transition metal complex or the ligand which can form a bleach-boosting transition metal complex with a transition metal in situ in the washing process. In a further preferred embodiment of the invention, a washing agent is used which contains peroxygenated bleaching agent, bleach-boosting transition metal complex, or a ligand which can form a bleach-boosting transition metal complex with a transition metal in situ in the washing process, and a cation-complexing, cation-exchanging and/or cation-precipitating substance. Such a washing agent that is gentle on textiles is also provided by the invention.

Washing agents according to the invention can be present in solid form or as liquids or pastes and can be used as such in machine or hand washing processes, but can also be used as washing agent additives and/or as laundry or textile pretreatment agents.

Washing agent additives according to the invention can be used together with a conventional washing agent. This makes sense if the user wishes to improve bleaching performance of the conventional washing agent. In laundry pretreatment, agents according to the invention are used to improve removal of ingrained dirt or stains, particularly “problem stains” such as coffee, tea, red wine, grass or fruit juice, which are difficult to remove by washing with conventional textile washing agents but which are susceptible to oxidative attack. A further area of application of such agents is the removal of localized soiling of otherwise clean surfaces, so that a more laborious washing or cleaning process of the corresponding entire piece, whether an item of clothing or a carpet or an upholstered item of furniture, can be avoided. In this regard, it is possible to simply apply the agent, optionally with an amount of water which is not sufficient to completely dissolve the agent, to the textile surface or part thereof to be cleaned, optionally introduce mechanical energy, for example, by rubbing with a cloth or a sponge, and after a time determined by the user, remove the agent and the dirt broken down by oxidation by washing out with water, for example, with the aid of a damp cloth or sponge.

Agents according to the invention preferably contain 0.01 wt. % to 0.5 wt. %, particularly 0.02 wt. % to 0.3 wt. % of the bleach-boosting transition metal complex. Alternatively or additionally, the agent can also contain only one or more ligands which can form a bleach-boosting transition metal complex with a transition metal in situ in the washing process. The transition metal can be present in the washing agent in the form of a salt or non-bleach-boosting complex, or introduced into the washing process as part of the service water used for the process or via the textile to be cleaned, for example, as a constituent of the dirt removed.

In addition to the peroxygenated bleaching agent, the bleach-boosting transition metal complex or ligand which can form the bleach-boosting transition metal complex in situ and the cation-complexing, cation-exchanging and/or cation-precipitating substance, washing and cleaning agents according to the invention may contain those known ingredients conventionally used in such agents. In particular, the washing and cleaning agents can contain builder substances, surfactants, enzymes, sequestering agents, electrolytes, pH regulators, special-effect polymers such as soil-release polymers, color transfer inhibitors, graying inhibitors, crease-reducing active agents and shape-retaining active agents, and other auxiliary substances such as optical brighteners, foam regulators, additional peroxygen activators, dyes and fragrances, the cation-complexing, cation-exchanging and/or cation-precipitating representatives among the builders, surfactants and sequestering agents being suitable as the aforementioned cation-complexing, cation-exchanging and cation-precipitating substances for the method, for the use and for use in agents according to the invention.

Useful peroxygen compounds which can be used in the method, for the use and in the agents according to the invention include organic peracids or peracid salts of organic acids such as phthalimidoperhexanoic acid, perbenzoic acid or salts of diperdodecanedioic acid, hydrogen peroxide and inorganic salts which give off hydrogen peroxide under the washing conditions, including alkali perborate, alkali percarbonate, alkali persilicate and/or alkali persulfate such as caroate. If solid peroxygen compounds are used, they can be used in the form of powders or granules which can also be coated in a manner known in the art. The addition of small amounts of known bleaching agent stabilizers such as phosphonates, borates or metaborates and metasilicates, as well as magnesium salts such as magnesium sulfate can be useful. An agent according to the invention preferably contains 15 wt. % to 50 wt. %, particularly 18 wt. % to 35 wt. %, of peroxygenated bleaching agent, in particular alkali percarbonate. Alternatively or additionally, hydrogen peroxide can also be produced in the present method by an enzymatic system, namely an oxidase in combination with its substrate, which in a preferred embodiment of the invention are ingredients of the agent and which can replace the peroxygenated bleaching agent in the agent either partially or preferably completely.

In addition to the bleach-boosting transition metal complex compound, further compounds known as bleach-activating active ingredients can be used in the agents if desired, particularly conventional bleach activators (i.e., compounds which under perhydrolysis conditions give rise to optionally substituted perbenzoic acid and/or peroxocarboxylic acids having 1 to 10 C atoms, particularly 2 to 4 C atoms). Conventional bleach activators carrying 0 and/or N acyl groups of the cited C atomic number and/or optionally substituted benzoyl groups are suitable. Polyacylated alkylene diamines, particularly tetraacetyl ethylenediamine (TAED), acylated glycolurils such as tetraacetyl glycoluril (TAGU), acylated triazine derivatives such as 1,5-diacetyl-2,4-dioxohexahydro-1,3,5-triazine (DADHT), acylated phenyl sulfonates such as nonanoyloxy or isononanoyloxy benzene sulfonate, acylated polyhydric alcohols such as triacetin, ethylene glycol diacetate and 2,5-diacetoxy-2,5-dihydrofuran as well as acetylated sorbitol and mannitol, and acylated sugar derivatives such as pentaacetyl glucose (PAG), pentaacetyl fructose, tetraacetyl xylose and octaacetyl lactose, as well as acetylated, optionally N-alkylated glucamine and gluconolactone, are preferred. Nitriles forming perimidic acids under perhydrolysis conditions (e.g., acetonitriles bearing ammonium groups) can also be used.

Agents according to the invention are preferably free from such conventional bleach activators.

Agents according to the invention can contain one or more surfactants, with anionic surfactants, non-ionic surfactants and mixtures thereof being particularly suitable. Suitable non-ionic surfactants include alkyl glycosides and ethoxylation and/or propoxylation products of alkyl glycosides or linear or branched alcohols having 12 to 18 C atoms in the alkyl part and 3 to 20, preferably 4 to 10, alkyl ether groups. Corresponding ethoxylation and propoxylation products of N-alkylamines, vicinal diols, fatty acid esters and fatty acid amides, which in terms of the alkyl part correspond to the cited long-chain alcohol derivatives, and alkyl phenols having 5 to 12 C atoms in the alkyl residue can also be used.

Suitable anionic surfactants include soaps and examples containing sulfate or sulfonate groups, with preferably alkali ions as cations. Soaps which can be used are preferably the alkali salts of saturated or unsaturated fatty acids having 12 to 18 C atoms. Such fatty acids can also be used in not completely neutralized form. Suitable sulfate surfactants include salts of sulfuric acid semi-esters of fatty alcohols having 12 to 18 C atoms and sulfation products of the cited non-ionic surfactants with a low degree of ethoxylation. Suitable sulfonate surfactants include linear alkylbenzene sulfonates having 9 to 14 C atoms in the alkyl part, alkane sulfonates having 12 to 18 C atoms, and olefin sulfonates having 12 to 18 C atoms which are formed in the reaction of corresponding monoolefins with sulfur trioxide, as well as alpha-sulfo fatty acid esters which are formed in the sulfonation of fatty acid methyl or ethyl esters.

Such surfactants are included in the cleaning or washing agents in amounts of preferably 5 wt. % to 50 wt. %, in particular 8 wt. % to 30 wt. %, based on total weight of the agent.

Agents according to the invention preferably contains at least one water-soluble and/or water-insoluble, organic and/or inorganic builder. Water-soluble organic builder substances include polycarboxylic acids, particularly citric acid and sugar acids, monomeric and polymeric aminopolycarboxylic acids, particularly methylglycine diacetic acid, nitrilotriacetic acid, ethylenediamine-N,N′-disuccinic acid and ethylenediamine tetraacetic acid as well as polyaspartic acid, polyphosphonic acids, particularly amino tris(methylene phosphonic acid), ethylenediamine tetrakis(methylene phosphonic acid) and 1-hydroxyethane-1,1-diphosphonic acid, polymeric hydroxy compounds such as dextrin, as well as polymeric (poly)carboxylic acids, particularly polycarboxylates obtainable by oxidation of polysaccharides or dextrins, polymeric acrylic acids, methacrylic acids, maleic acids and mixed polymers thereof, which can also contain small amounts of polymerizable substances without carboxylic acid functionality incorporated by polymerization. The relative molecular mass of the homopolymers of unsaturated carboxylic acids is generally from 5000 to 200,000, that of the copolymers from 2000 to 200,000, preferably 50,000 to 120,000, relative to free acid.

A particularly preferred acrylic acid-maleic acid copolymer has a relative molecular mass of 50,000 to 100,000. Suitable although less preferred compounds of this class include copolymers of acrylic acid or methacrylic acid with vinyl ethers, such as vinyl methyl ethers, vinyl esters, ethylene, propylene and styrene, wherein the proportion of acid is at least 50 wt. %. Terpolymers containing two unsaturated acids and/or the salts thereof as monomers along with vinyl alcohol and/or an esterified vinyl alcohol or a carbohydrate as the third monomer can also be used as water-soluble organic builder substances. The first acid monomer or salt thereof is derived from a monoethylenically unsaturated C₃-C₈ carboxylic acid and preferably from a C₃-C₄ monocarboxylic acid, in particular, from (meth)acrylic acid. The second acid monomer or salt thereof can be a derivative of a C₄-C₈ dicarboxylic acid, maleic acid being particularly preferred, and/or a derivative of an allyl sulfonic acid which is substituted in the 2-position with an alkyl or aryl residue. Such polymers generally have a relative molecular mass of from 1000 to 200,000. Further preferred copolymers are those preferably having acrolein and acrylic acid/acrylic acid salts or vinyl acetate as monomers. All the cited acids are generally used in the form of their water-soluble salts, in particular their alkali salts.

Such organic builder substances can be included if desired in amounts of up to 40 wt. %, in particular up to 25 wt. % and preferably from 1 wt. % to 8 wt. %.

Suitable water-soluble, inorganic builder materials include polymeric alkali phosphates, which can be present in the form of their alkaline, neutral or acid sodium or potassium salts. Examples thereof are tetrasodium diphosphate, disodium dihydrogen diphosphate, pentasodium triphosphate, and sodium hexametaphosphate, as well as the corresponding potassium salts or mixtures of sodium and potassium salts. Crystalline or amorphous alkali aluminosilicates: in particular can be used as water-insoluble, water-dispersible inorganic builder materials in amounts of up to 50 wt. %, preferably not over 40 wt. %, and in liquid agents in particular in amounts of 1 wt. % to 5 wt. %. Of these, the crystalline sodium aluminosilicates in washing agent grade, particularly Zeolite A, P and optionally X are preferred. Amounts close to the cited upper limit are preferably used in solid, particulate agents. Particularly useful aluminosilicates have no particles with a particle size of more than 30 μm, and preferably consist of at least 80 wt. % of particles with a size of less than 10 μm. Their calcium-binding capacity (which can be determined by the method described in German patent DE 24 12 837) is generally in the range from 100 to 200 mg CaO per gram.

Suitable substitutes or partial substitutes for the cited aluminosilicates are crystalline alkali silicates, which can be present alone or mixed with amorphous silicates. Alkali silicates that can be used as builders in the agents preferably have a molar ratio of alkali oxide to SiO₂ of less than 0.95, particularly from 1:1.1 to 1:12, and can be amorphous or crystalline. Preferred alkali silicates are sodium silicates, particularly amorphous sodium silicates, with a molar ratio of Na₂O:SiO₂ of 1:2 to 1:2.8. Crystalline layered silicates of the general formula Na₂SiₓO₂ₓ₊₁.y H₂O are preferably used as crystalline silicates, which can be present alone or mixed with amorphous silicates, in which the modulus x is a number from 1.9 to 4 and y is a number from 0 to 20, with preferred values for x being 2, 3 or 4. Preferred crystalline layered silicates are those wherein x has the values 2 or 3 in the cited general formula. In particular, both 13- and 8-sodium disilicates (Na₂Si₂O₅.y H₂O) are preferred. Virtually anhydrous crystalline alkali silicates of the aforementioned general formula prepared from amorphous alkali silicates, wherein x is a number from 1.9 to 2.1, can also be used in agents according to the invention. In a further preferred embodiment, a crystalline sodium layered silicate with a modulus of 2 to 3 is used, such as can be prepared from sand and soda. Crystalline sodium silicates with a modulus in the range from 1.9 to 3.5 are used in a further preferred embodiment. In a preferred embodiment, a granular compound of alkali silicate and alkali carbonate is used, such as is commercially available under the name Nabion® 15. If alkali aluminosilicate, particularly zeolite, is also present as an additional builder substance, the weight ratio of aluminosilicate to silicate, relative to anhydrous active substances, is preferably 1:10 to 10:1. In agents containing both amorphous and crystalline alkali silicates, the weight ratio of amorphous alkali silicate to crystalline alkali silicate is preferably 1:2 to 2:1 and particularly 1:1 to 2:1.

Preferably, builder substances are present in washing or cleaning agents according to the invention in amounts of up to 60 wt. %, particularly from 5 wt. % to 40 wt. %, while disinfecting agents according to the invention are preferably free from builder substances which complex only the water hardness components and preferably contain no more than 20 wt. %, particularly from 0.1 wt. % to 5 wt. %, of heavy-metal-complexing substances, preferably from aminopolycarboxylic acids, aminopolyphosphonic acids and hydroxypolyphosphonic acids and the water-soluble salts thereof and mixtures thereof.

In a preferred embodiment, an agent according to the invention has a water-soluble builder block. The term “builder block” is intended to convey the fact that the agents contain no further builder substances as such which are water-soluble; in other words, all builder substances present in the agent are brought together in the “block”, excluding if need be the amounts of substances which in typical commercial practice can be contained in small amounts in the other ingredients of the agents as impurities or as stabilizing additives. The term “water-soluble” should be understood to mean that in the concentration produced by the amount that is used of the agent containing it, the builder block dissolves without residue in typical conditions. Agents according to the invention preferably contain at least 15 wt. % and up to 55 wt. %, particularly 25 wt. % to 50 wt. %, of water-soluble builder block. This is preferably composed of the following components—
a) 5 wt. % to 35 wt. % of citric acid, alkali citrate and/or alkali carbonate, at least part of which can also be replaced by alkali hydrogen carbonate,
b) up to 10 wt. % of alkali silicate with a modulus in the range from 1.8 to 2.5,
c) up to 2 wt. % of phosphonic acid and/or alkali phosphonate,
d) up to 50 wt. % of alkali phosphate, and
e) up to 10 wt. % of polymeric polycarboxylate,
   the specified amounts based on total washing or cleaning agent. The same applies to all other specified amounts unless expressly stated otherwise.

In a preferred embodiment, the water-soluble builder block contains at least two of components b), c), d) and e) in amounts greater than 0 wt. %.

Regarding component a), in a preferred embodiment the agents contain 15 wt. % to 25 wt. % of alkali carbonate, at least part of which can be replaced by alkali hydrogen carbonate, and up to 5 wt. %, particularly 0.5 wt. % to 2.5 wt. %, of citric acid and/or alkali citrate. In an alternative embodiment they contain as component a) 5 wt. % to 25 wt. %, particularly 5 wt. % to 15 wt. %, of citric acid and/or alkali citrate, and up to 5 wt. %, particularly 1 wt. % to 5 wt. %, of alkali carbonate, at least part of which can be replaced by alkali hydrogen carbonate. If both alkali carbonate and alkali hydrogen carbonate are present, component a) preferably contains alkali carbonate and alkali hydrogen carbonate in a weight ratio of 10:1 to 1:1.

Regarding component b), in a preferred embodiment the agents contain 1 wt. % to 5 wt. % of alkali silicate with a modulus in the range from 1.8 to 2.5.

Regarding component c), in a preferred embodiment the agents contain 0.05 wt. % to 1 wt. % of phosphonic acid and/or alkali phosphonate. Phosphonic acids here refer to optionally substituted alkyl phosphonic acids, which can also have several phosphonic acid groupings (known as polyphosphonic acids). They are preferably chosen from hydroxyalkyl and/or aminoalkyl phosphonic acids and/or the alkali salts thereof, such as dimethylaminomethane diphosphonic acid, 3-aminopropane-1-hydroxy-1,1-diphosphonic acid, 1-amino-1-phenylmethane diphosphonic acid, 1-hydroxyethane-1,1-diphosphonic acid (HEDP), amino-tris-(methylene phosphonic acid), N,N,N′,N′-ethylenediamine tetrakis(methylene phosphonic acid), diethylenetriamine penta(methylene phosphonic acid) (DPTMP) and acylated derivatives of phosphoric acid, which can also be used in any mixtures.

Regarding component d), in a preferred embodiment the agents contain 15 wt. % to 35 wt. % of alkali phosphate, particularly trisodium polyphosphate. Alkali phosphate is the summary term for the alkali metal salts (particularly sodium and potassium) of the various phosphoric acids, among which it is possible to differentiate between metaphosphoric acids (HPO₃)ₙ and orthophosphoric acid H₃PO₄ and higher-molecular-weight representatives. Phosphates provide several advantages—they act as alkali carriers, prevent limescale deposits on machine parts or limescale encrustations in fabrics, and contribute to cleaning performance. Sodium dihydrogen phosphate (NaH₂PO₄) exists in both dihydrate (density 1.91 gcm⁻³, melting point 60°) and monohydrate (density 2.04 gcm⁻³) form. Both salts are white powders which are very readily soluble in water, lose water of crystallization when heated and convert at 200° C. to the weakly acid diphosphate (disodium hydrogen diphosphate, Na₂H₂P₂O₇) and at higher temperatures to sodium trimetaphosphate (Na₃P₃O₉) and Madrell's salt. NaH₂PO₄ undergoes an acid reaction and is formed when phosphoric acid is adjusted to a pH of 4.5 with sodium hydroxide solution and the mash is atomized. Potassium dihydrogen phosphate (primary or monobasic potassium phosphate, potassium biphosphate, KDP), KH₂PO₄, is a white salt of density 2.33 gcm³, has a melting point of 253° (breaks down to form (KPO₃)ₓ, potassium polyphosphate) and is readily soluble in water. Disodium hydrogen phosphate (secondary sodium phosphate), Na₂HPO₄, is a colorless, very readily water-soluble crystalline salt. It exists in anhydrous form and with 2 mol (density 2.066 gcm⁻³, water loss at 95°), 7 mol (density 1.68 gm⁻³, melting point 48° with loss of 5 H₂O) and 12 mol of water (density 1.52 gcm⁻³, melting point 35° with loss of 5 H₂O), becomes anhydrous at 100° and if heated above that temperature converts to the diphosphate Na₄P₂O₇. Disodium hydrogen phosphate is produced by neutralizing phosphoric acid with soda solution using phenolphthalein as indicator. Dipotassium hydrogen phosphate (secondary or dibasic potassium phosphate), K₂HPO₄, is an amorphous white salt which is readily soluble in water. Trisodium phosphate, tertiary sodium phosphate, Na₃PO₄, takes the form of colorless crystals which in dodecahydrate form have a density of 1.62 gcm⁻³ and a melting point of 73-76° C. (decomposition), in decahydrate form (corresponding to 19-20% P₂O₅) have a melting point of 100° C. and in anhydrous form (corresponding to 39-40% P₂O₅) have a density of 2.536 gcm⁻³. Trisodium phosphate is readily soluble in water with an alkaline reaction and is produced by evaporating a solution of exactly 1 mol of disodium phosphate and 1 mol of NaOH. Tripotassium phosphate (tertiary or tribasic potassium phosphate), K₃PO₄, is a white, deliquescent, granular powder of density 2.56 gcm³, has a melting point of 1340° and is readily soluble in water with an alkaline reaction. It is formed by heating basic slag with carbon and potassium sulfate, for example. Despite the higher price, the more readily soluble and therefore highly active potassium phosphates are much preferred over corresponding sodium compounds in the cleaning agent industry. Tetrasodium diphosphate (sodium pyrophosphate), Na₄P₂O₇, exists in anhydrous form (density 2.534 gcm⁻³, melting point 988°, 880° also given) and in decahydrate form (density 1.815-1.836 gcm⁻³, melting point 94° with water loss). Substances are colorless crystals which are soluble in water with an alkaline reaction. Na₄P₂O₇ is formed by heating disodium phosphate to over 200° or by reacting phosphoric acid with soda in a stoichiometric ratio and dewatering the solution by atomization. The decahydrate complexes heavy metal salts and hardness constituents and therefore reduces water hardness. Potassium diphosphate (potassium pyrophosphate), K₄P₂O₇, exists in the trihydrate form and is a colorless, hygroscopic powder with a density of 2.33 gcm⁻³ which is soluble in water, the pH of the 1% solution at 25° being 10.4. Condensation of NaH₂PO₄ or KH₂PO₄ produces higher-molecular-weight sodium and potassium phosphates, within which a distinction can be made between cyclic representatives, the sodium or potassium metaphosphates, and chain-like types, the sodium or potassium polyphosphates. There are many terms in use for the latter group in particular: fused or calcined phosphate, Graham's salt, Kurrol's and Madrell's salt. All higher sodium and potassium phosphates are together referred to as condensed phosphates. The technically important pentasodium triphosphate, Na₅P₃O₁₀ (sodium tripolyphosphate), is a non-hygroscopic, white, water-soluble salt which is anhydrous or crystallizes with 6 H₂O, of the general formula NaO—[P(O)(ONa)—O]ₙ—Na where n=3. In 100 g of water around 17 g of the water-of-crystallization-free salt dissolve at room temperature, approx. 20 g at 60° and around 32 g at 100°; after heating the solution at 100° for two hours, approximately 8% orthophosphate and 15% diphosphate are formed by hydrolysis. In the production of pentasodium triphosphate phosphoric acid is reacted with soda solution or sodium hydroxide solution in a stoichiometric ratio and the solution is dewatered by atomization. Similarly to Graham's salt and sodium diphosphate, pentasodium triphosphate dissolves many insoluble metal compounds (including lime soaps, etc.). Pentapotassium triphosphate, K₅P₃O₁₀ (potassium tripolyphosphate), is commercially available in the form of a 50 wt. % solution (>23% P₂O₅, 25% K₂O), for example. The potassium polyphosphates are widely used in the washing and cleaning agent industry. Sodium potassium tripolyphosphates also exist, and they can likewise be used within the context of the present invention. These are formed for example when sodium trimetaphosphate is hydrolyzed with KOH—

(NaPO₃)₃+2 KOH→Na₃K₂P₃O₁₀+H₂O

These can be used according to the invention in exactly the same way as sodium tripolyphosphate, potassium tripolyphosphate or mixtures of the two; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used according to the invention.

Regarding component e), in a preferred embodiment the agents contain 1.5 wt. % to 5 wt. % of polymeric polycarboxylate, chosen in particular from the polymerization or copolymerization products of acrylic acid, methacrylic acid and/or maleic acid. Of these, homopolymers of acrylic acid and those having an average molar mass in the range from 5000 D to 15,000 D (PA standard) are particularly preferred.

In addition to the aforementioned oxidase, also suitable as enzymes which can be used in the agents are those from the class of proteases, lipases, cutinases, amylases, pullulanases, mannanases, cellulases, hemicellulases, xylanases and peroxidases and mixtures thereof, for example proteases such as BLAP®, Optimase®, Opticlean®, Maxacal®, Maxapem®, Alcalase®, Esperase®, Savinase®, Durazym® and/or Purafect® OxP, amylases such as Termamyl®, Amylase-LT®, Maxamyl®, Duramyl® and/or Purafect® OxAm, lipases such as Lipolase®, Lipomax®, Lumafast® and/or Lipozym®, cellulases such as Celluzyme® and/or Carezyme®. Enzymatic active ingredients obtained from fungi or bacteria, such as Bacillus subtilis, Bacillus licheniformis, Streptomyces griseus, Humicola lanuginosa, Humicola insolens, Pseudomonas pseudoalcaligenes or Pseudomonas cepacia, are particularly suitable. The optionally used enzymes can be adsorbed on supporting materials and/or embedded in coating substances to protect them against premature inactivation. They are preferably contained in the washing, cleaning and disinfecting agents according to the invention in amounts of up to 10 wt. %, particularly 0.2 wt. % to 2 wt. %, enzymes stabilized against oxidative degradation being particularly preferably used.

In a preferred embodiment, the agent contains 5 wt. % to 50 wt. %, particularly 8 to 30 wt. % of anionic and/or non-ionic surfactant, up to 60 wt. %, particularly 5 to 40 wt. % of builder substance, and 0.2 wt. % to 2 wt. % of enzyme chosen from proteases, lipases, cutinases, amylases, pullulanases, mannanases, cellulases, oxidases and peroxidases and mixtures thereof.

To set a desired pH that is not established automatically by mixing the other components on addition of water, which is preferably in the range from 5 to 12, particularly 7 to 11 and more particularly 8 to 10 (relative to the washing liquor), the agents can contain system-compatible and environmentally compatible acids, particularly citric acid, acetic acid, tartaric acid, malic acid, lactic acid, glycolic acid, succinic acid, glutaric acid and/or adipic acid, but also mineral acids, particularly sulfuric acid, or bases, in particular ammonium or alkali hydroxides. Such pH regulators are included in the agents in amounts preferably not exceeding 20 wt. %, particularly 1.2 wt. % to 17 wt. %.

Polymers having the ability to release dirt, often known as soil release active agents, or, because of their ability to make the treated surface (e.g., fibers) dirt repellent, as soil repellents, include non-ionic or cationic cellulose derivatives. Polyester-active soil release polymers include copolyesters of dicarboxylic acids such as adipic acid, phthalic acid or terephthalic acid, diols such as ethylene glycol or propylene glycol, and polydiols such as polyethylene glycol or polypropylene glycol. Soil release polyesters which are preferably used include those compounds obtainable by esterification of two monomer components, the first monomer being a dicarboxylic acid HOOC-Ph-COOH and the second monomer being a diol HO—(CHR²¹—)ₐOH, which can also be present as the polymeric diol H—(O—(CHR²¹—)ₐ)_{b}OH. Ph here is an o-, m- or p-phenyl residue which can bear 1 to 4 substituents chosen from alkyl residues having 1 to 22 C atoms, sulfonic acid groups, carboxyl groups and mixtures thereof, R²¹ is hydrogen, an alkyl residue having 1 to 22 C atoms and mixtures thereof, a is a number from 2 to 6 and b a number from 1 to 300. Polyesters obtainable therefrom preferably contain both monomer diol units —O—(CHR²¹—)ₐO— and polymer diol units —(O—(CHR²¹—)ₐ)_{b}O—. The molar ratio of monomer diol units to polymer diol units is preferably 100:1 to 1:100, particularly 10:1 to 1:10. In the polymer diol units the degree of polymerization b is preferably in the range from 4 to 200, in particular from 12 to 140. The molecular weight or average molecular weight or maximum of the molecular weight distribution of preferred soil release polyesters is in the range from 250 to 100,000, particularly 500 to 50,000. The acid on which the residue Ph is based is preferably chosen from terephthalic acid, isophthalic acid, phthalic acid, trimellitic acid, mellitic acid, the isomers of sulfophthalic acid, sulfoisophthalic acid and sulfoterephthalic acid and mixtures thereof. If their acid groups are not part of the ester bonds in the polymer, they are preferably present in salt form, particularly as alkali or ammonium salt. Of these, the sodium and potassium salts are particularly preferred. If desired, small amounts, particularly not more than 10 mol % relative to the amount of Ph with the meaning given above, of other acids having at least two carboxyl groups can be included in the soil release polyester in place of the monomer HOOC-Ph-COOH. These include alkylene and alkenylene dicarboxylic acids such as malonic acid, succinic acid, fumaric acid, maleic acid, glutaric acid, adipic acid, pimelic acid, suberic acid, azelaic acid and sebacic acid. Preferred diols HO—(CHR²¹—)ₐOH include those in which R²¹ is hydrogen and a is a number from 2 to 6 and those in which a has the value 2 and R¹¹ is chosen from hydrogen and alkyl residues having 1 to 10, particularly 1 to 3 C atoms. Of the last-named diols, those of the formula HO—CH₂—CHR¹¹—OH, in which R¹¹ has the meaning given above, are particularly preferred. Diol components include ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. Among the polymeric diols, polyethylene glycol with an average molar mass in the range from 1000 to 6000 is particularly preferred. These polyesters can also be end capped if desired, alkyl groups having 1 to 22 C atoms and esters of monocarboxylic acids being suitable as end groups. End groups bonded via ester bonds can be based on alkyl, alkenyl and aryl monocarboxylic acids having 5 to 32 C atoms, particularly 5 to 18 C atoms. These include pentanoic acid, hexanoic acid, heptanoic acid, octanoic acid, nonanoic acid, decanoic acid, undecanoic acid, undecenoic acid, dodecanoic acid, lauroleic acid, tridecanoic acid, tetradecanoic acid, myristoleic acid, pentadecanoic acid, palmitic acid, stearic acid, petroselic acid, petroselaidic acid, oleic acid, linoleic acid, linolelaidic acid, linolenic acid, eleostearic acid, eicosanoic acid, gadoleic acid, arachidonic acid, behenic acid, erucic acid, brassidic acid, clupanodonic acid, tetracosanoic acid, hexacosanoic acid, triacontanoic acid, benzoic acid which can bear 1 to 5 substituents having a total of up to 25 C atoms, particularly 1 to 12 C atoms, for example tert-butylbenzoic acid. End groups can also be based on hydroxymonocarboxylic acids having 5 to 22 C atoms, which include hydroxyvaleric acid, hydroxycaproic acid, ricinoleic acid, the hydrogenation products thereof, hydroxystearic acid and o-, m- and p-hydroxybenzoic acid. The hydroxymonocarboxylic acids for their part can be linked to one another by their hydroxyl group and their carboxyl group and can thus be present in an end group multiple times. The number of hydroxymonocarboxylic acid units per end group, i.e. their degree of oligomerization, is preferably in the range from 1 to 50, particularly from 1 to 10. In a preferred embodiment, polymers of ethylene terephthalate and polyethylene oxide terephthalate, in which the polyethylene glycol units have molecular weights of 750 to 5000 and the molar ratio of ethylene terephthalate to polyethylene oxide terephthalate is 50:50 to 90:10, are used alone or in combination with cellulose derivatives.

Suitable color transfer inhibitors for use in agents according to the invention for washing textiles include polyvinyl pyrrolidones, polyvinyl imidazoles, polymeric N-oxides such as poly(vinylpyridine-N-oxide) and copolymers of vinyl pyrrolidone with vinyl imidazole and optionally other monomers.

Agents according to the invention for use in washing textiles can contain anti-creasing agents, since textile fabrics, particularly those made from rayon, wool, cotton and mixtures thereof, can tend to crease as the individual fibers are susceptible to being flexed, folded, pressed and crushed transversely to the fiber direction. These include synthetic products based on fatty acids, fatty acid esters, fatty acid amides, fatty alkylol esters, fatty alkylol amides or fatty alcohols, which are mostly reacted with ethylene oxide, or products based on lecithin or modified phosphoric acid esters.

Graying inhibitors keep dirt released from the hard surface, particularly from textile fibers, suspended in the liquor. Water-soluble colloids, mostly of an organic nature, are suitable for this purpose such as starch, glue, gelatin, salts of ether carboxylic acids or ether sulfonic acids of starch or cellulose or salts of acid sulfuric acid esters of cellulose or starch. Water-soluble polyamides containing acid groups are also suitable for this purpose. Starch derivatives other than those mentioned above can also be used, for example aldehyde starches. Cellulose ethers such as carboxymethyl cellulose (Na salt), methyl cellulose, hydroxyalkyl cellulose and mixed ethers, such as methylhydroxyethyl cellulose, methylhydroxypropyl cellulose, methylcarboxymethyl cellulose and mixtures thereof, are preferably used, for example in amounts of 0.1 to 5 wt. %, relative to the agents.

The agents can contain optical brighteners, in particular, derivatives of diaminostilbene disulfonic acid or the alkali metal salts thereof. Salts of 4,4′-bis(2-anilino-4-morpholino-1,3,5-triazinyl-6-amino)stilbene-2,2′-disulfonic acid or similarly structured compounds bearing a diethanolamino group, a methylamino group, an anilino group or a 2-methoxyethylamino group in place of the morpholino group, are suitable. Brighteners of the substituted diphenyl styryl type can also be present, for example, the alkali salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the optical brighteners can also be used.

For use in machine washing and cleaning methods in particular it can be advantageous to add conventional foam inhibitors to the agents. Soaps of natural or synthetic origin, for example, having a high proportion of C₁₈ to C₂₄ fatty acids are suitable as foam inhibitors. Suitable non-surfactant foam inhibitors are for example organopolysiloxanes and mixtures thereof with microfine, optionally silanized silicic acid and paraffins, waxes, microcrystalline waxes and mixtures thereof with silanized silicic acid or bis-fatty acid alkylene diamides. Mixtures of various foam inhibitors are also used to advantage, for example those comprising silicones, paraffins or waxes. The foam inhibitors, in particular silicone- and/or paraffin-containing foam inhibitors, are preferably bonded to a granular, water-soluble or water-dispersible carrier substance. Mixtures of paraffins and bistearyl ethylenediamide are preferred in particular.

Active agents for preventing the tarnishing of silver objects, known as silver corrosion inhibitors, can also be used in the present agents. Preferred silver corrosion protection agents are organic disulfides, divalent phenols, trivalent phenols, optionally alkyl- or aminoalkyl-substituted triazoles such as benzotriazole, as well as cobalt, manganese, titanium, zirconium, hafnium, vanadium or cerium salts and/or complexes, in which the cited metals are in one of the oxidation states II, III, IV, V or VI.

To strengthen the disinfection action against specific germs, the agent can contain conventional antimicrobial active agents in addition to the previously mentioned constituents. Such antimicrobial additives are preferably present in teh agents in amounts not exceeding 10 wt. %, particularly 0.1 wt. % to 5 wt. %.

A cleaning agent according to the invention for hard surfaces can further contain ingredients having an abrasive action, particularly from the group comprising silica flour, wood flour, plastics flour, chalks and micro glass balls and mixtures thereof. Abrasive substances are included in cleaning agents according to the invention in amounts preferably not exceeding 20 wt. %, particularly 5 wt. % to 15 wt. %.

### EXAMPLES

Primary washing power and wet tensile strength loss were tested in a miniaturized washing test. A simplified washing liquor consisting of H₂O₂ and catalyst (1,4,7-trimethyl-1,4,7-triazacyclononane-manganese complex, MnTACN) was used. Solutions of 0.35 g/l of H₂O₂ and 4.1 mg/l of MnTACN were used, each containing 0, 0.5 or 1.5 mmol/l of the complexing agent 1-hydroxyethane-1,1-diphosphonic acid (HEDP) in distilled water (0° dH), the pH values being adjusted with NaOH in each case to pH 10 or pH 11.

To measure primary washing performance, cotton substrates bearing a standardized tea stain were treated for 30 minutes at 30° C. in the various solutions. The treated fabric substrate was washed out under running water, then dried and the color value measured. The table below shows the brightness value of the cotton test pieces.

To measure wet tensile strength loss, cotton strips of a defined width (thread count) were treated in the various solutions 20 times, in each case for 45 minutes at 60° C. The strips were dried and dipped in a wetting solution before being torn apart on a tensile testing machine at a constant tensile testing rate. The tensile strength at break point of the treated cotton was compared with the tensile strength at break point of the untreated cotton, and the wet tensile strength loss in % was calculated.

Five sets of measurements were carried out for both primary washing power and wet tensile strength loss. The mean values are given in the table below.

| | | Bleaching power | Wet tensile |
|---|---|---|---|
| | pH | [Y value] | strength loss [%] |
| H₂O₂ + | 10 | 58.4 | 49 |
| MnTACN | | | |
| H₂O₂ + | 10 | 55.8 | 18 |
| MnTACN + | | | |
| 0.5 mM HEDP | | | |
| H₂O₂ + | 10 | 55.8 | 16 |
| MnTACN + | | | |
| 1.5 mM HEDP | | | |
| H₂O₂ + | 11 | 66.8 | 94 |
| MnTACN | | | |
| H₂O₂ + | 11 | 65.7 | 55 |
| MnTACN + | | | |
| 1.5 mM HEDP | | | |

When water with a hardness of 16° dH rather than 0° dH was used, the results of the wet tensile strength loss test for H₂O₂+MnTACN and for H₂O₂+MnTACN+1.5 mM HEDP were not significantly different from those obtained using water with a hardness of 0° dH.

We claim:

1. Method for washing textiles comprising:
washing textiles in the presence of a peroxygenated bleaching agent and a bleach-boosting transition metal complex at a water hardness of 0° dH to 3° dH.

2. Method according to claim 1, further comprising washing the textiles at a temperatures in a range from 10° C. to 95° C.

3. Method according to claim 1, further comprising adding cation-complexing, cation-exchanging or cation-precipitating substances in an amount larger than necessary to adjust water hardness in a washing liquor to a value in the range from 0° dH to 3° dH.

4. Method according to claim 3, wherein phosphonates, complexing polymers, ion-exchanging substances and/or complexing surface-active substances are used.

5. Method according to claim 4, wherein the concentration of phosphonate in the washing liquor is 0.01 mmol/l to 10 mmol/l.

6. Method according to claim 4, wherein the concentration of complexing polymer in the washing liquor is 0.001 g/l to 5 g/l.

7. Method according to claim 4, wherein the concentration of ion-exchanging substance in the washing liquor is 0.01 g/l to 100 g/1.

8. Method according to claim 4, wherein the concentration of complexing surface-active substance in the washing liquor is 0.01 g/l to 50 g/l.

9. Method according to claim 1, wherein peroxygen concentration (calculated as H₂O₂) in washing liquor is in the range from 0.001 g/l to 10 g/l.

10. Method according to claim 1, wherein a concentration of bleach-boosting transition metal complex in washing liquor is in the range from 0.1 μmol/l to 100 μmol/l.

11. Method according to claim 1, wherein the bleach-boosting transition metal complex is derived from one or more ligands which can form a bleach-boosting transition metal complex with a transition metal in situ in the washing process, wherein the transition metal is added separately in the form of a salt or non-bleach-boosting complex or introduced into the washing process as a component of the service water used for washing or from the textiles.

12. Method according to claim 1, wherein the bleach-boosting transition metal complex compound is a metal complex of formula (I)
[LₙMₘXₚ]^{Z}Y_{q} (I)
wherein M is manganese or iron or mixtures of these metals, which can be present in oxidation state II, III, IV or V, or in mixtures thereof; n and m are independently of one another whole numbers having a value from 1 to 4; X is a coordinating or bridging species; p is a whole number having a value from 0 to 12; Y is a counterion whose type is dependent on the charge z of the complex, which can be positive, zero or negative; q=z/[charge Y]; and L is a ligand which is a macrocyclic organic molecule of the general formula 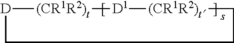
wherein each of residues R¹ and R² can be zero, H, alkyl or aryl, optionally substituted; t and t′ are independently of one another 2 or 3; D and D′ are independently of each other N, NR, PR, O or S, where R denotes H, alkyl or aryl, optionally substituted; and s is a whole number with a value from 2 to 5, where, if D=N, one of the heterocarbon bonds bonded thereto is unsaturated, leading to the formation of an N═CR¹ section.

13. Method according to claim 12, wherein in the complex according to formula (I) M is manganese and L is 1,4,7-triazacyclononane, 1,4,7-trimethyl-1,4,7-triazacyclononane, 1,5,9-trimethyl-1,5,9-triazacyclododecane or 1,2,4,7-tetramethyl-1,4,7-triazacyclononane.

14. Method according to claim 1, wherein the bleach-boosting transition metal complex compound is a manganese complex of formula (II) 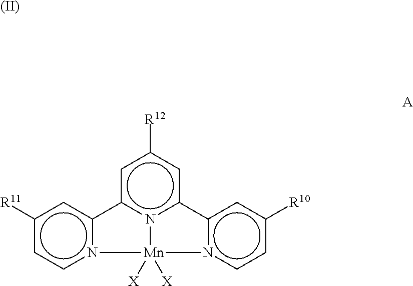
wherein R¹⁰ and R¹¹ independently of one another are hydrogen, C₁₋₁₈ alkyl group, —NR¹³R¹⁴ group, —N+R¹³R¹⁴R¹⁵ group or 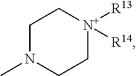
R¹² is hydrogen, —OH or a C₁₋₁₈ alkyl group; R¹³, R¹⁴ and R¹⁵ independently of one another are hydrogen, a C₁₋₄ alkyl or hydroxyalkyl group; X is halogen; and A is a charge-equalizing anion which, depending on its charge and on the type and number of other charges can also be absent or be present multiple times.

15. Method according to claim 1, further comprising premixing the bleach-boosting transition metal complex with phosphonate.

16. Washing agent gentle on textiles comprising peroxygenated bleaching agent, bleach-boosting transition metal complex or one or more ligands which can form a bleach-boosting transition metal complex with a transition metal in situ in a washing process, and a cation-complexing, cation-exchanging and/or cation-precipitating substance.
